(19) United States
(12) Patent Application Publication
(10) Pub. No.: US 2017/0116382 A1
(43) Pub. Date: Apr. 27, 2017

(54) PATIENT CARE RECONNAISSANCE SYSTEM

(71) Applicant: JLM MedTech, Inc., Santa Clara, CA (US)

(72) Inventors: Jason Reminick, Santa Clara, CA (US); Manu Gujrati, San Francisco, CA (US)

(21) Appl. No.: 14/923,162

(22) Filed: Oct. 26, 2015

(51) Int. Cl. G06F 19/00

(52) U.S. Cl. CPC G06F 19/3418; G06F 19/323

(57) ABSTRACT

A system and methods for patient care reconnaissance, including: obtaining a set of parameters from a set of patient tags and a set of care provider tags in at least one of a set of predetermined locations, each set of parameters describing activities involving a set of patients and a set of care providers identified by the patient and care provider tags; associating each set of parameters with an identifier of the corresponding predetermined location; and receiving the parameters from the predetermined locations and in response generating depictions of activities of the patients and care providers.

### BACKGROUND

A patient undergoing medical treatment can interact with a variety of care providers in a variety of locations. For example, a patient admitted to a hospital for a surgical procedure can move among radiology rooms, pre-op rooms, holding rooms, post-op rooms, etc., before being moved to an operating room for the surgical procedure.

At any given point in the course of medical treatment it can be important, even critical, for care providers to know what locations and what care providers a patient has previously visited. For example, a doctor, e.g., a surgeon, anesthesiologist, etc., on duty in a pre-op room may need to know whether a patient has already visited radiology or another pre-op room and what care providers were present in those rooms prior to being moved to an operating room.

Traditional procedures for keeping track of the movements of patients through treatment locations can be time consuming and labor intensive, thereby driving up the cost and decreasing quality of providing medical care. Traditional procedures for keeping track of the movements of patients through treatment locations can also be error prone, thereby putting patients and their families at risk of avoidable pain and suffering in experiencing system-wide inefficiencies.

### SUMMARY

In general, in one aspect, the invention relates to a patient care reconnaissance system. The patient care reconnaissance system can include: a set of patient tags each for identifying a respective patient; a set of care provider tags each for identifying a respective care provider; a set of proximity detectors capable of communicating with the patient and care provider tags and obtaining a set of parameters describing each of a set of care interactions involving the patients and the care providers; and an intelligence center that gathers the parameters from the proximity detectors and that in response to a request generates a depiction of a process of care for at least one of the patients.

In general, in another aspect, the invention relates to a method for patient care reconnaissance. The method can include: obtaining a set of parameters from a set of patient tags and a set of care provider tags in at least one of a set of predetermined locations, each set of parameters describing a respective care interaction involving a set of patients and a set of care providers identified by the patient and care provider tags; associating each set of parameters with an identifier of the corresponding predetermined location; and receiving the parameters from the predetermined locations and in response to a request generating a depiction of a process of care for at least one of the patients.

In general, in yet another aspect, the invention relates to a patient care reconnaissance system. The patient care reconnaissance system can include: a patient tag for identifying a patient; a set of proximity detectors each capable of sampling a respective set of patient location parameters when the patient tag is in range; and an intelligence center that gathers the patient location parameters from the proximity detectors and that generates a depiction of a spatial-temporal history of the patient sampled by the proximity detectors.

In general, in still another aspect, the invention relates to a method for patient care reconnaissance. The method can include: obtaining a respective set of patient location parameters from a patient tag in at least one of a set of predetermined locations; associating each set of patient location parameters with an identifier of the corresponding predetermined location; and receiving the patient location parameters from the predetermined locations and generating a depiction of a spatial-temporal history of a patient associated with the patient tag in response to the patient location parameters.

Other aspects of the invention will be apparent from the following description and the appended claims.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIGS. 1A-1B illustrate embodiments of a patient care reconnaissance system.

FIG. 2 shows how a set of proximity detectors can be placed about various locations so that the unique detector identifiers of the proximity detectors identify particular locations.

FIG. 3 shows an example of a depiction of a process of care for a set of patients of a care provider in one or more embodiments.

FIG. 4 shows another example of a depiction of a process of care in one or more embodiments.

FIG. 5 illustrates a care provider location tracker and a patient location tracker in an intelligence center in one or more embodiments.

FIG. 6 illustrates a data correlator and a user interface in an intelligence center in one or more embodiments.

FIG. 7 shows how a variety of users, e.g., care providers, administrators, analysts, can access an intelligence center via a network.

FIG. 8 illustrates a method for patient care reconnaissance in one or more embodiments.

FIG. 9 shows an embodiment of an intelligence center that generates a spatial-temporal history for one or more of patients.

FIG. 10 illustrates a method for patient care reconnaissance in one or more other embodiments.

FIG. 11 illustrates a computing system upon which portions of a patient care reconnaissance system can be implemented.

### DETAILED DESCRIPTION

Reference will now be made in detail to the various embodiments of the present disclosure, examples of which are illustrated in the accompanying drawings. Like elements in the various figures are denoted by like reference numerals for consistency. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, have not been described in detail so as not to unnecessarily obscure aspects of the present disclosure.

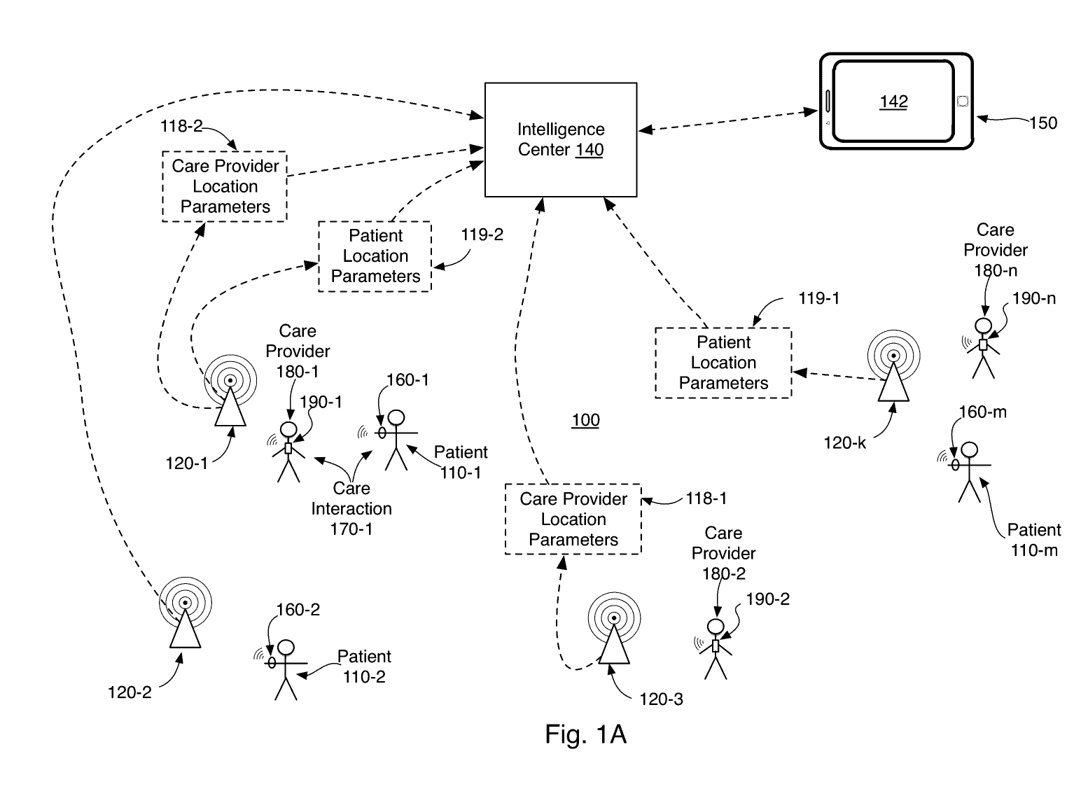

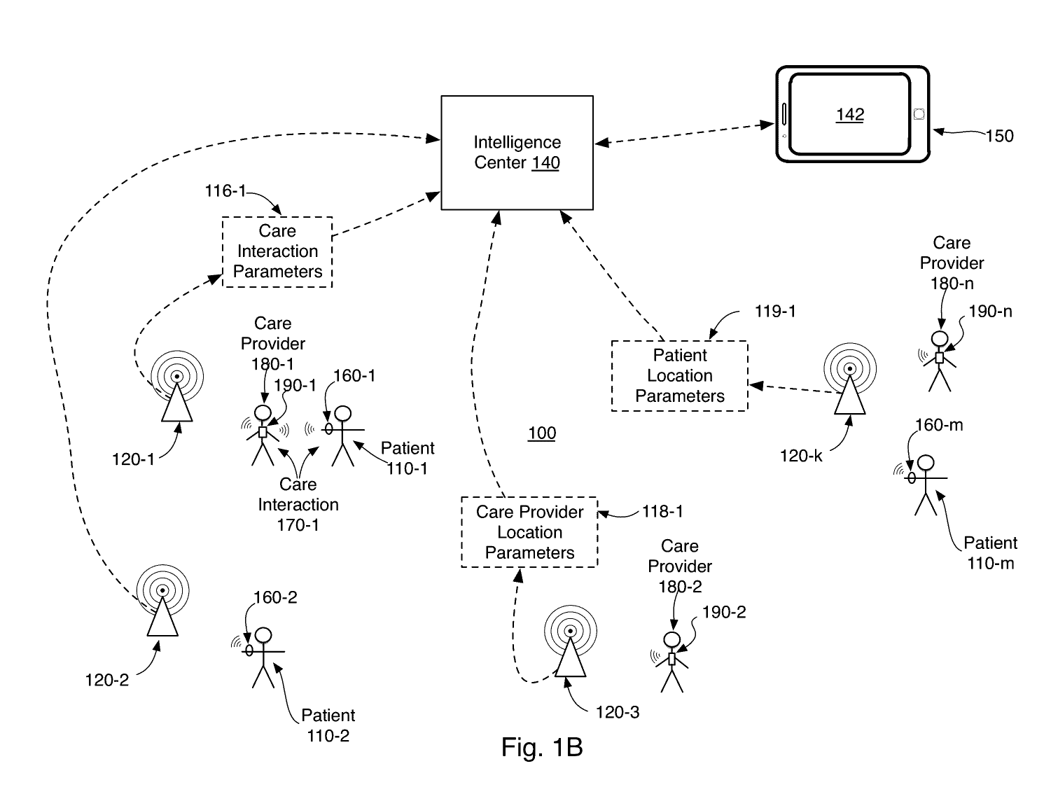

FIG. 1A illustrates a patient care reconnaissance system 100 in one or more embodiments. The patient care reconnaissance system 100 includes a set of care provider tags 190-1 through 190-n each for identifying a respective care provider 180-1 through 180-n and further includes a set of patient tags 160-1 through 160-m each for identifying a respective patient 110-1 through 110-m.

The care provider tags 190-1 through 190-n can be embodied as badges. The care provider tags 190-1 through 190-n are each encoded with a respective unique care provider identifier assigned to the respective care provider 180-1 through 180-n. There can be any number, n, of the care provider tags 190-1 through 190-n.

The patient tags 160-1 through 160-m can be embodied as wristbands. The patient tags 160-1 through 160-m are each encoded with a respective unique patient identifier assigned to the respective patient 110-1 through 110-m. There can be any number, m, of the patient tags 160-1 through 160-m.

The patient care reconnaissance system 100 includes a set of proximity detectors 120-1 through 120-k. The proximity detectors 120-1 through 120-k can be embodied as portable devices that can be moved and swapped out as needed. The proximity detectors 120-1 through 120-k are each encoded with a respective unique detector identifier. There can be any number, k, of the proximity detectors 120-1 through 120-k. The proximity detectors 120-1 through 120-k can be distributed about various locations, e.g., in a hospital, so that the unique detector identifier of the proximity detector 120-1 identifies to a particular location.

The proximity detectors 120-1 through 120-k each include circuitry for communicating with the care provider tags 190-1 through 190-n and obtaining a respective set of care provider location parameters 118-1 through 118-p when one of the care provider tags 190-1 through 190-n comes within range. There can be any number, p, of sets of care provider location parameters 118-1 through 118-p sampled by the proximity detectors 120-1 through 120-k.

For example, the proximity detector 120-3 generates the care provider location parameters 118-1 when the care provider tag 190-2 comes within sampling range of the proximity detector 120-3. The care provider location parameters 118-1 include the unique care provider identifier sampled from the care provider tag 190-2, a corresponding timestamp indicating when the care provider tag 190-2 came within sampling range of the proximity detector 120-3, and the unique detector identifier of the proximity detector 120-3. For example, if the proximity detector 120-3 is placed in a pre-op examination room then the unique detector identifier of the proximity detector 120-3 included in the care provider location parameters 118-1 indicates that the care provider tag 190-2, and therefore the care provider 180-2, was sampled in that pre-op examination room.

The proximity detectors 120-1 through 120-k each include circuitry for communicating with the patient tags 160-1 through 160-m and obtaining a respective set of patient location parameters 119-1 through 119-r when one of the patient tags 160-1 through 160-m comes within range. For example, the proximity detector 120-k generates the patient location parameters 119-1 when the patient tag 160-m comes within sampling range of the proximity detector 120-k. The patient location parameters 119-1 include the unique patient identifier sampled from the patient tag 160-m, a corresponding timestamp indicating when the patient tag 160-m came within sampling range of the proximity detector 120-k, and the unique detector identifier of the proximity detector 120-k. There can be any number, r, of sets of patient location parameters sampled by the proximity detectors 120-1 through 120-k.

The patient tags 160-1 through 160-m and the care provider tags 190-1 through 190-n can each include an integrated circuit chip that stores the respective unique patient identifier or unique care provider identifier and a transmitter for broadcasting the respective unique patient identifier or unique care provider identifier to the proximity detectors 120-1 through 120-k using, e.g., Bluetooth low energy wireless communication.

In one or more embodiments, the proximity detectors 120-1 through 120-k generate a corresponding timestamp in response to a unique patient identifier or a unique care provider identifier received from the patient tags 160-1 through 160-m and the care provider tags 190-1 through 190-n. In some embodiments, the proximity detectors 120-1 through 120-k detect when the patient tags 160-1 through 160-m and the care provider tags 190-1 through 190-n are in range and broadcast a query to sample the unique patient identifiers and unique care provider identifiers from the patient tags 160-1 through 160-m and the care provider tags 190-1 through 190-n.

In some embodiments, wearable devices can be used to broadcast the unique patient identifiers and unique care provider identifiers to the proximity detectors 120-1 through 120-k.

The patient care reconnaissance system 100 includes an intelligence center 140 that gathers the care provider location parameters 118-1 through 118-p and the patient location parameters 119-1 through 119-r from the proximity detectors 120-1 through 120-k. The intelligence center 140 can obtain the care provider location parameters 118-1 through 118-p and the patient location parameters 119-1 through 119-r from the proximity detectors 120-1 through 120-k via a local wireless network, e.g., Wi-Fi, or a local wired network, e.g., Ethernet. The intelligence center 140 can be a local service in an information technology center associated with a patient care facility, e.g., an information technology center of a hospital. The intelligence center 140 can be a cloud-based service. The intelligence center 140 can obtain the parameters from the proximity detectors 120-l through 120-k via the Internet using web protocols.

The intelligence center 140 uses the care provider location parameters 118-1 through 118-p and the patient location parameters 119-1 through 119-r to detect a set of care interactions 170-1 through 170-i involving the patients 110-1 through 110-m and the care providers 180-1 through 180-n. There can be any number, i, of the care interactions 170-1 through 170-i involving the care providers 180-1 through 180-n and the patients 110-1 through 110-m. For example, the intelligence center 140 compares the timestamp and unique detector identifier in the care provider location parameters 118-2 to the timestamp and the unique detector identifier in the patient location parameters 119-2 detect a care interaction 170-1 involving the patient 110-1 and the care provider 180-1. The care interaction 170-1 can be an event or milestone associated with a process of care which the patient 110-1 is undergoing. For example, if the patient 110-1 is undergoing a surgical procedure then the care interaction 170-1 may be a pre-op examination by the care provider 180-1, e.g., an anesthesiologist, or a surgeon, etc.

The intelligence center 140 uses the parameters gathered from the proximity detectors 120-1 through 120-k to generate a depiction 142 of a process of care for one or more of the patients 110-1 through 110-m in response to a request. The request for the depiction 142 can by made by any of the care providers 180-1 through 180-n or by some other person. The request can target only patients of a particular care provider or set of care providers. In this example, the depiction 142 is rendered on a mobile device 150. The mobile device 150 can be used to make the request for the depiction 142.

The depiction 142 can include an indication of at least one care interaction. For example, the depiction 142 can include the care interaction 170-1. The depiction 142 of the care interaction 170-1 can include a description. For example, a description can include a statement that an x-ray was taken or a blood test performed. A description can include results, e.g., results of an x-ray or blood test. The intelligence center 140 can obtain descriptions of care interactions from electronic medical records entries made by the particular care provider. The intelligence center 140 can be integrated with and incorporated into an already established hospital/health system electronic medical records.

The depiction 142 can enable a care provider or other user to provide a description of a care interaction included in the depiction 142. For example, the care provider 180-1 can touch or tap an interface element of the depiction 142 on the mobile device 150 that enables the care provider 180-1 to enter a description of a blood test or other test involved in the care interaction 170-1 and the results using text or voice input, etc.

The depiction 142 can include an indication of at least one location, e.g., a current location or a previous location or a series of locations, of any of the patients 110-1 through 110-m. The intelligence center 140 can determine the location histories of the patients 110-1 through 110-m using the unique patient identifiers and unique detector identifiers and associated timestamps in the patient location parameters 119-1 through 119-r. The intelligence center 140 can determine which of the patients 110-1 through 110-m are patients of a particular care provider specified in the request for the depiction 142 by accessing a set of electronic medical records, e.g. electronic medical records of a hospital information technology center, large healthcare system, etc.

The depiction 142 can include an indication of a current location of the patient of a particular care provider specified in the request for the depiction 142 who is nearest to a current location of the particular care provider. The intelligence center 140 can determine the nearest location of the patients 110-1 through 110-m of the particular care provider using the unique patient identifiers, unique care provider identifiers, unique detector identifiers, and associated timestamps in the care provider location parameters 118-1 through 118-p and the patient location parameters 119-1 through 119-r.

The depiction 142 can include an interface element that enables viewing of a set of medical records. For example, the depiction 142 can include a list of patients of the care provider 180-1 including the patient 110-1. When the care provider 180-1 touches or taps on the name of the patient 110-1 a popup view can appear on the mobile device 150 of the care provider 180-1 that provides access to electronic medical records for the patient 110-1 via, e.g., integration with existing electronic medical records.

The depiction 142 can include an indication of the care provider 180-1 through 180-n having a most recent care interaction with a particular patient of a particular care provider specified in the request for the depiction 142. The intelligence center 140 determine the most recent care interaction to be included in the depiction 142 using the unique patient identifiers, the unique care provider identifiers, the timestamps, and the unique detector identifiers in the parameters gathered from the proximity detectors 120-1 through 120-k.

The depiction 142 can include a spatial-temporal history of at least one of the care providers sampled by the proximity detectors. The intelligence center 140 determine the spatial-temporal history to be included in the depiction 142 using the unique care provider identifiers, the associated timestamps, and the unique detector identifiers in the parameters gathered from the proximity detectors 120-1 through 120-k.

FIG. 1B illustrates the patient care reconnaissance system 100 in one or more embodiments in which the care provider tags 190-1 through 190-n and the patient tags 160-1 through 160-m enable the proximity detectors 120-1 through 120-k obtain a respective set of care interaction parameters 116-1 through 116-i for each respective set of care interactions 170-1 through 170-i. For example, the proximity detector 120-1 includes circuitry for communicating with the patient tag 160-1 and the care provider tag 190-1 and obtaining the care interaction parameters 116-1 describing the care interaction 170-1 involving the patient 110-1 and the care provider 180-1.

The care interaction parameters 116-1 can include the unique patient identifier of the patient 110-1 sampled from the patient tag 160-1. The care interaction parameters 116-1 can include the unique care provider identifier of the care provider 180-1 sampled from the care provider tag 190-1. The care interaction parameters 116-1 can include a timestamp associated with the care interaction 170-1. The proximity detector 120-1 can generate the timestamp associated with the care interaction 170-1 when it obtains the unique patient identifier from the patient tag 160-1. The proximity detector 120-1 can generate the timestamp associated with the care interaction 170-1 when it obtains the unique care provider identifier from the care provider tag 190-1. The proximity detector 120-1 can generate the timestamp associated with the care interaction 170-1 when it obtains a signal from the patient tag 160-1 or from the care provider tag 190-1 indicating that the care interaction 170-1 has occurred.

The patient tags 160-1 through 160-m and the care provider tags 190-1 through 190-n in one or more embodiments can include communication circuits for detecting the care interactions 170-1 through 170-i between the care providers 180-1 through 180-n and the patients 110-1 through 110-m. The communication circuits for detecting the care interactions 170-1 through 170-i can be based on Bluetooth low energy wireless communication, near field communication (NFC), optical bar code readers, RFID circuits, communication channels based on physical contact between badges and wristbands, etc., to name a couple of examples. The patient tags 160-1 through 160-m and the care provider tags 190-1 through 190-n can transmit the parameters of a detected care interaction to a nearby proximity detectors 120-1 through 120-k via, e.g., Bluetooth low energy wireless communication.

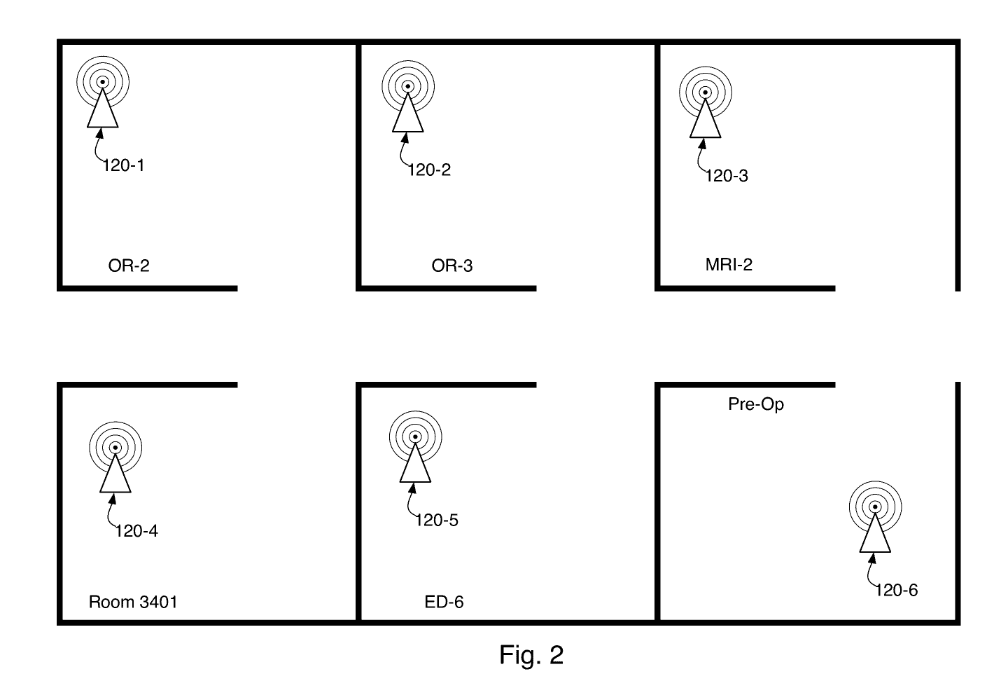

FIG. 2 shows how the proximity detectors 120-1 through 120-k can be placed about various locations in a patient care facility, e.g. a hospital, so that the unique detector identifiers of the proximity detectors 120-1 through 120-k identify particular locations in the patient care facility. For example, the proximity detector 120-1 is placed in operating room 2, OR-2, so that when the intelligence center 140 obtains a set of parameters that includes the unique detector identifier of the proximity detector 120-1 it will associate those parameters with the location of OR-2. Likewise, parameters that include the unique detector identifier of the proximity detector 120-6 will be associated with a Pre-Op location.

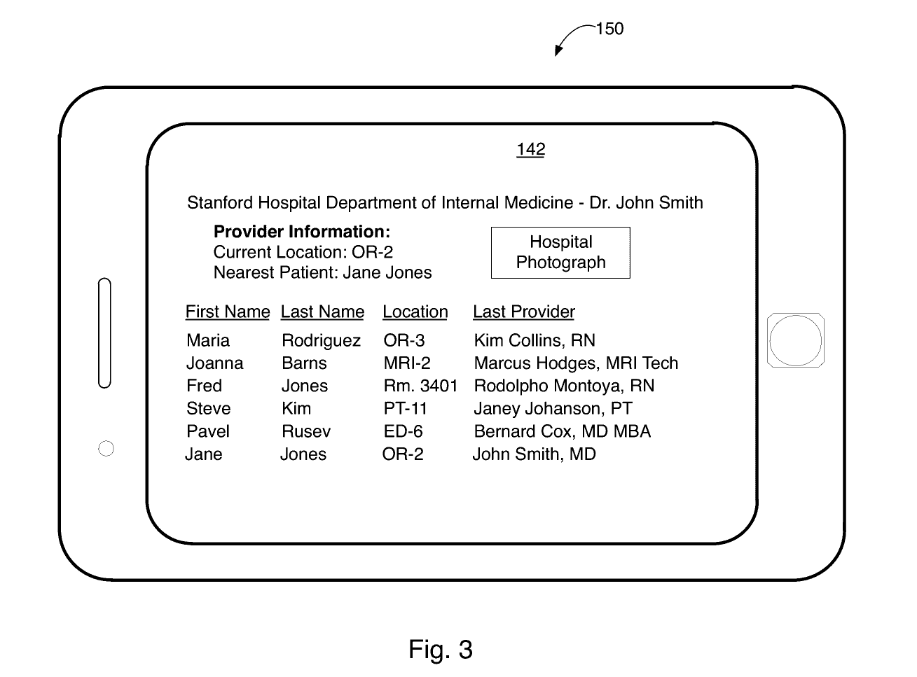

FIG. 3 shows an example of the depiction 142 on the mobile device 150 in one or more embodiments. In this example, the depiction 142 is a home page for a particular care provider, Dr. John Smith, of the care providers 180-1 through 180-n who is currently in OR-2 when he accesses his home page.

The depiction 142 in this example includes a list of the patients of Dr. John Smith, along with their locations and the last care providers visited by each of them. For example, patient Maria Rodriguez is currently in OR-3 and her last care interaction was with nurse Kim Collins. The locations OR-3, MRI-2, Room 3401, PT-11, ED-6, and OR-2, are locations, e.g., in a hospital (FIG. 2), that are covered by the proximity detectors 120-1 through 120-k.

In one or more embodiments, the intelligence center 140 generates the depiction 142 so that when Dr. John Smith selects, e.g., by touching, tapping, etc., a patient name in the depiction 142 a popup view appears on the mobile device 150 that provides electronic medical records access for the selected patient via, e.g., integration with existing electronic medical records. For example, Dr. Smith can tap on the name Maria Rodriguez to bring up medical records pertaining to Maria.

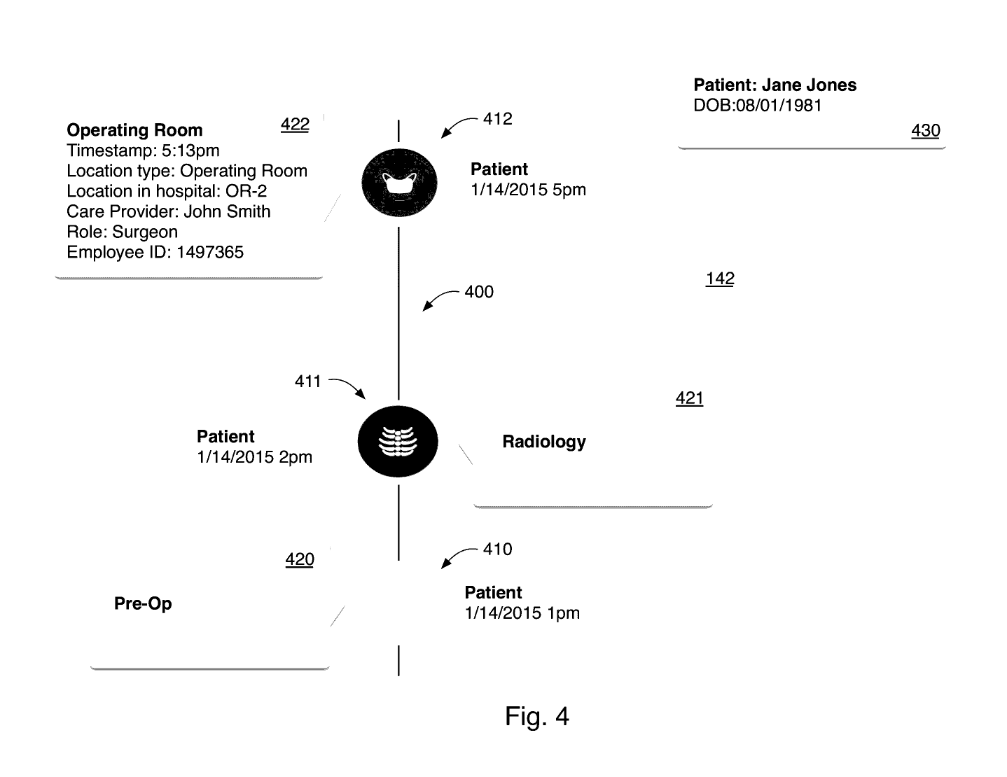

FIG. 4 shows another example of the depiction 142 in one or more embodiments. In this example, the depiction 142 includes a timeline 400 indicating a process of care for a particular patient—Jane Jones. The depiction 142 includes a view 430 that identifies the patient by the name associated with her patient tag. The timeline 400 includes a series of icons 410-412, each corresponding to a time-stamped sample of the unique patient identifier obtained from Jane's patient tag by the proximity detectors 120-1 through 120-k.

The icon 410 indicates that the patient tag of Jane Jones was sampled on Jan. 14, 2015 at 1 pm by a proximity detector positioned in Pre-Op (FIG. 2). The icon 411 indicates that the patient tag of Jane Jones was sampled on Jan. 14, 2015 at 2 pm. The icon 412 indicates that the patient tag of Jane Jones was sampled on Jan. 14, 2015 at 5 pm. The images on the respective icons 410-412 indicate to a user a type of location corresponding to the timestamp samples. In this example, the icons 410-412 depict a map location image, a radiology image, and an operating room image, respectively.

A user can select the icons 410-412 individually, e.g., by clicking or touching, to display additional information in respective popup views 420-422. The popup view 420 indicates an arrival of patient Jane Jones at pre-op. The popup view 421 indicates an arrival of patient Jane Jones in a radiology room. The popup view 422 indicates an arrival of patient Jane Jones in OR-2. The popup view 422 indicates that Dr. John Smith came on duty, as indicated by a 5:13 pm timestamp of his care provider tag, in OR-2 after the patient Jane Jones arrived.

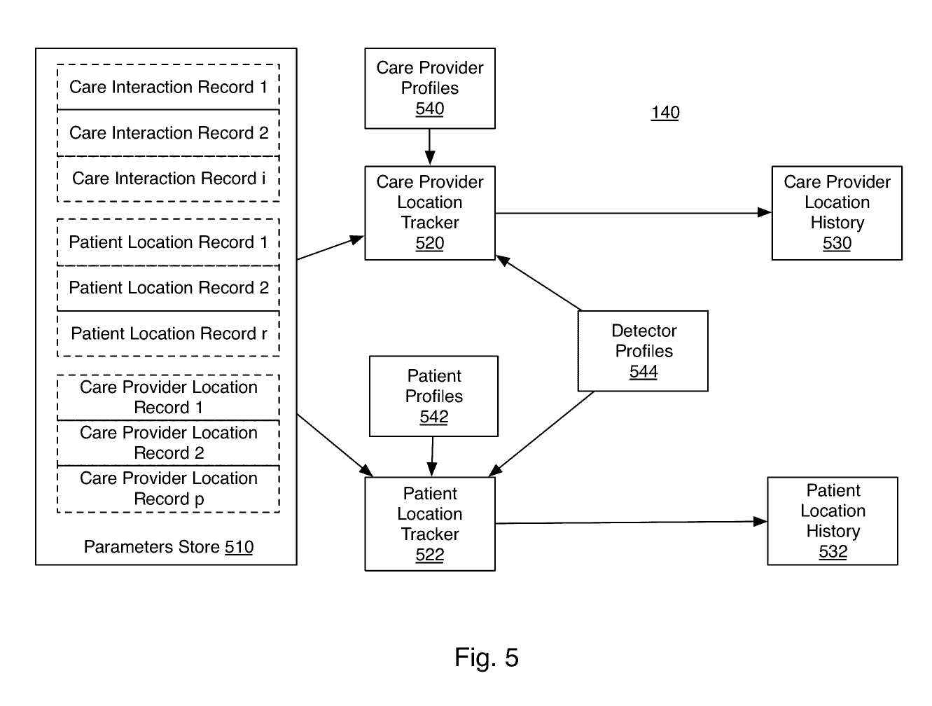

FIG. 5 illustrates a care provider location tracker 520 and a patient location tracker 522 in the intelligence center 140 in one or more embodiments. The care provider location tracker 520 generates a care provider location history 530 in response to the information in a parameters store 510 and the patient location tracker 522 generates a patient location history 532 in response to the information in the parameters store 510. The parameters store 510 holds the care interaction and location parameters gathered from the proximity detectors 120-1 through 120-k.

The parameters store 510 includes a set of care interaction records 1-i of the care interactions 170-1 through 170-i. Each care interaction record 1-i includes a unique patient identifier, a unique care provider identifier, a timestamp, and a detector identifier. The care interaction records 1-i can be records of the care interaction parameters 116-1 through 116-i gathered from the proximity detectors 120-1 through 120-k or equivalent parameters derived from the care provider location parameters 118-1 through 118-p and the patient location parameters 119-1 through 119-r.

The parameters store 510 includes a set of care provider location records 1-p of the care provider location parameters 118-1 through 118-p gathered from the proximity detectors 120-1 through 120-k. Each care provider location record 1-p includes a unique care provider identifier and a timestamp.

The parameters store 510 includes a set of patient location records 1-r of the patient location parameters 119-1 through 119-r gathered from the proximity detectors 120-1 through 120-k. Each patient location record 1-r includes a unique patient identifier and a timestamp.

The care provider location history 530 can include a series of location/time value pairs for each care provider 180-1 through 180-n sorted by increasing time values. The care provider location tracker 520 uses a set of care provider profiles 540 to translate unique care provider identifiers obtained from the parameters store 510 into care provider names, e.g. Dr. John Smith (FIG. 3) for the care provider location history 530. The care provider location tracker 520 uses a set of detector profiles 544 to translate unique detector identifiers obtained from the parameters store 510 into locations, e.g. OR-2, OR-3 (FIG. 2), etc., for the care provider location history 530.

Similarly, the patient location history 532 can include a series of location/time value pairs for each patient 110-1 through 110-m sorted by increasing time values. The patient location tracker 522 uses a set of patient profiles 542 to translate unique patient identifiers obtained from the parameters store 510 into patient names, e.g. Jane Jones (FIG. 4) for the patient location history 532. The patient location tracker 522 uses the detector profiles 544 to translate unique detector identifiers obtained from the parameters store 510 into locations, e.g. OR-2, OR-3 (FIG. 2), etc., for the patient location history 532.

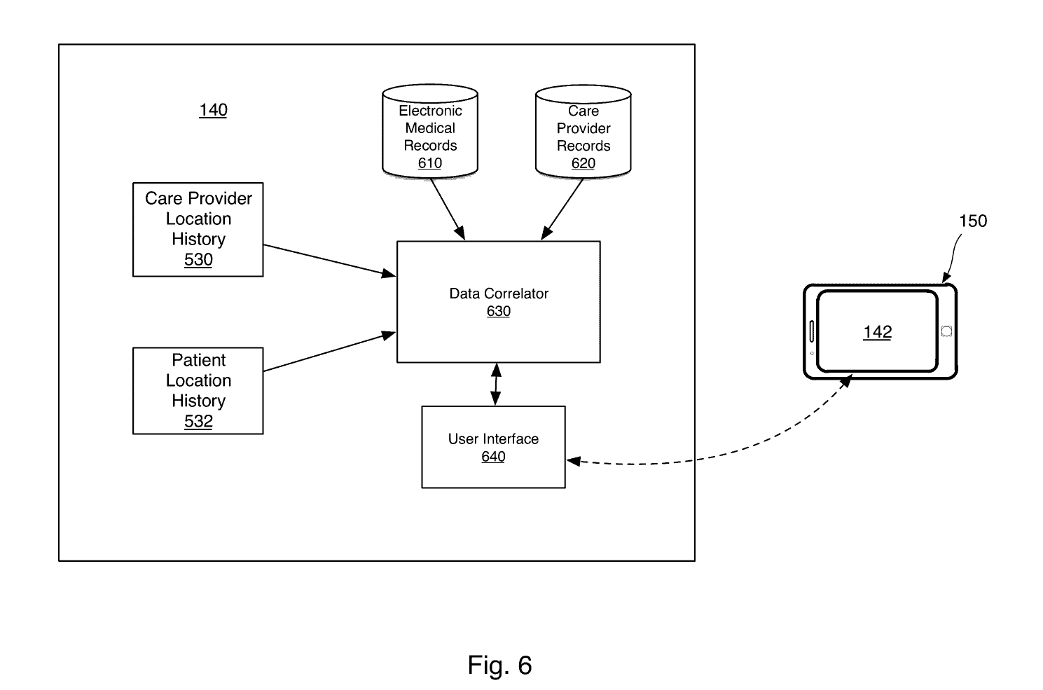

FIG. 6 illustrates a data correlator 630 and a user interface 640 in the intelligence center 140 in one or more embodiments. The user interface 640 enables a user of the mobile device 150, e.g., one of the care providers 180-1 through 180-n, to login to the intelligence center 140 and access the depiction 142, e.g., their home page (FIG. 3), a patient timeline (FIG. 4), etc.

The data correlator 630 gathers information for constructing the depiction 142 from the care provider location history 530 and the patient location history 532. The data correlator 630 can also access a set of electronic medical records 610 pertaining to the patients 110-1 through 110-m and a set of care provider records 620 that provides relevant professional information regarding the care providers 180-1 through 180-n, e.g. provider name, role, specialty, certification, title, department, pager number, etc.

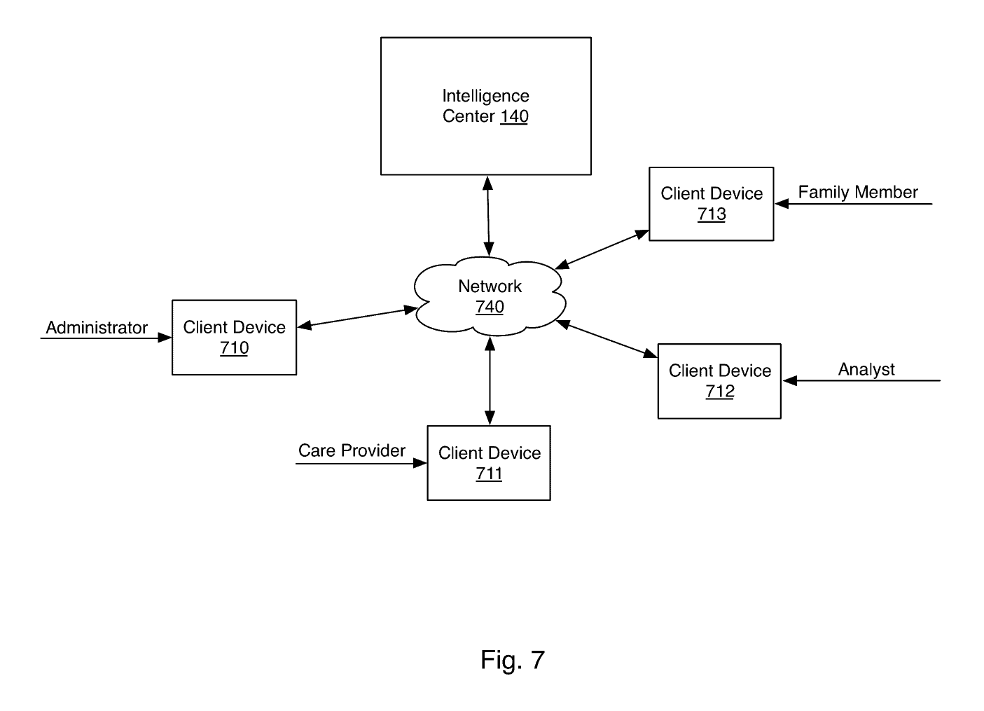

FIG. 7 shows how a variety of users, e.g., care providers, administrators, analysts, can access the intelligence center 140 via a network 740 using a client device of the intelligence center 140, e.g., the client devices 710-713, using web protocols. The client devices 710-713 can include computers, e.g., desktop, laptop, etc., mobile devices, e.g., smartphones, tablets, and wearable devices. The depiction 142 can be rendered on the client devices 710-713 using web protocols or mobile apps adapted to a user's mobile or wearable device.

The intelligence center 140 can generate the up-to-the-minute information for a number of the patients and care providers in response to requests made via the client devices 710-713. Such information, updated in real-time and including historical data, can provide care providers, administrators, family members of the patients 110-1 through 110-m, and others, with real-time views and histories of the patients 110-1 through 110-m and the care providers 180-1 through 180-n.

The patient care reconnaissance system 100 can be deployed in any healthcare facility, e.g., a hospital, clinic, emergency medical facility, physicians offices, etc. The patient care reconnaissance system 100 can encompass one structure or set of structures, e.g. a large or small hospital, or can include a number of structures widely dispersed geographically, inpatient, outpatient, large healthcare system, etc.

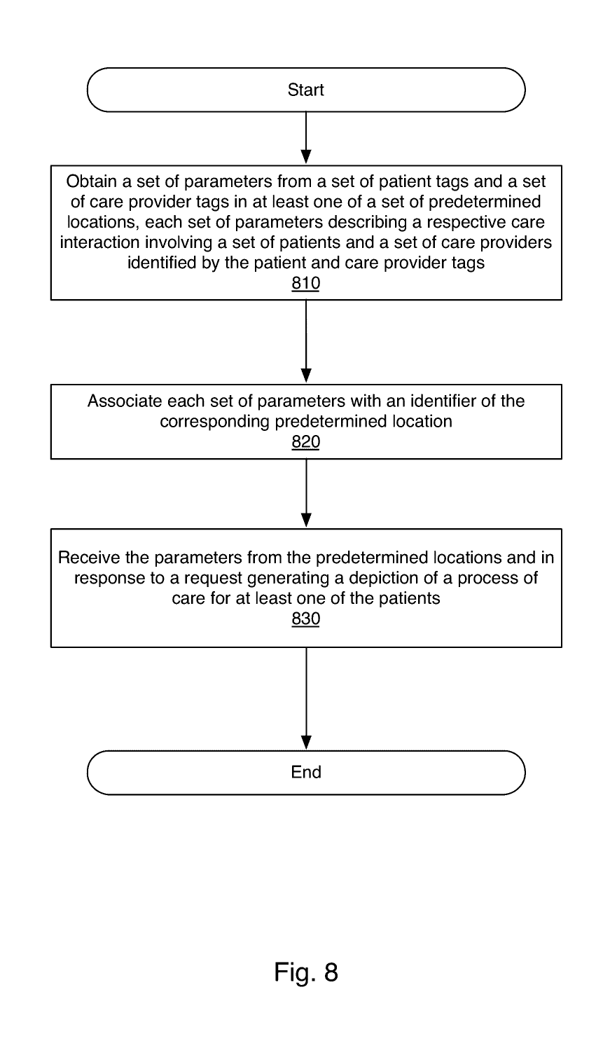

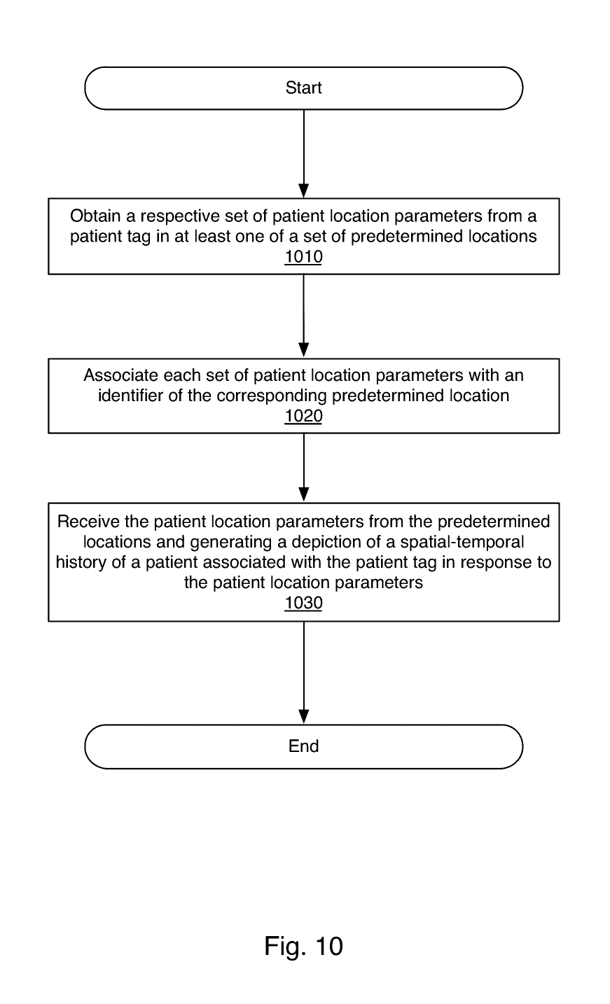

FIG. 8 illustrates a method for patient care reconnaissance in one or more embodiments. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIGS. 8 and 10 should not be construed as limiting the scope of the invention.

At step 810, a set of parameters is obtained from a set of patient tags and a set of care provider tags in at least one of a set of predetermined locations. Each set of parameters describes a respective care interaction involving a set of patients and a set of care providers identified by the patient and care provider tags.

At step 820, each set of parameters is associated with an identifier of the corresponding predetermined location. At step 830, the parameters from the predetermined locations are received and a depiction of a process of care for at least one of the patients of a particular care provider of the care providers is generated in response to a request from the particular care provider.

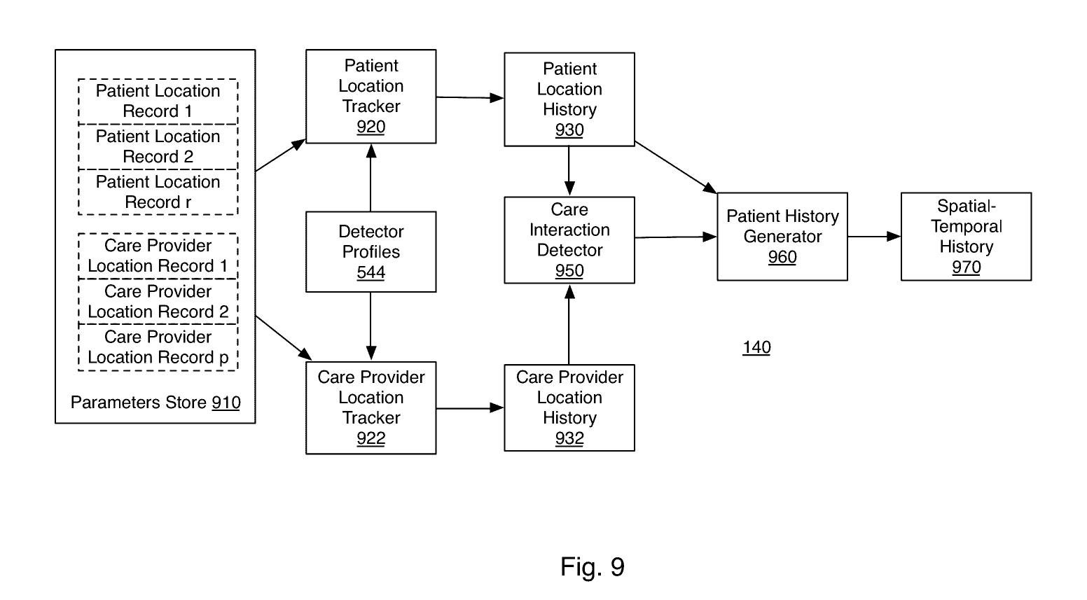

FIG. 9 shows an embodiment of the intelligence center 140 that generates a spatial-temporal history 970 for one or more of the patients 110-1 through 110-m in response to the patient location records 1-r and the care provider location records 1-p. The intelligence center 140 includes a patient location tracker 920 that generates a patient location history 930 in response to the patient location records 1-r and a care provider location tracker 922 that generates a care provider location history 932 in response to the care provider location records 1-p.

The intelligence center 140 includes a care interaction detector 950 that detects care interactions involving the patients 110-1 through 110-m and the care providers 180-1 through 180-n in response to the location/time value pairs from the patient location history 930 and the location/time value pairs from the care provider location history 932. For example, if the location/time value pairs from the patient location history 930 and the care provider location history 932 indicate that the patient 110-1 and the care provider 180-1 are at the same location at the same time then the care interaction detector 950 an infer the care interaction 170-1 from the matching location/time value pairs. In some embodiments, explicit indications of care interactions can be obtained from patient/care provider tags as previously described.

The intelligence center 140 includes a patient history generator 960 that generates the spatial-temporal history 970 for any of the patients 110-1 through 110-m. For example, the spatial-temporal history 970 for the patient 110-1 provides a depiction of a spatial-temporal history of the patient 110-1 sampled by the proximity detectors 120-1 through 120-k. The spatial-temporal history 970 can be accessed, e.g., from any of the client devices 710-713 via the network 740 from the intelligence center 140.

The spatial-temporal history 970 can depict a current location of a patient based on information from the patient location history 930. The spatial-temporal history 970 can depict one or more prior locations of a patient based on information from the patient location history 930. The spatial-temporal history 970 can depict one or more care interactions based on information from the care interaction detector 950. The spatial-temporal history 970 can depict one or more tables, timelines (FIG. 4), charts, maps, etc., of the movements over time of a patient as sampled by the proximity detectors 120-1 through 120-k.

FIG. 10 illustrates a method for patient care reconnaissance in one or more other embodiments. At step 1010, a respective set of patient location parameters is obtained from a patient tag in at least one of a set of predetermined locations. At step 1020, each set of patient location parameters is associated with an identifier of the corresponding predetermined location. At step 1030, the patient location parameters are received from the predetermined locations and a depiction of a spatial-temporal history of a patient associated with the patient tag is generated in response to the patient location parameters.

Embodiments of the invention may be implemented on a specialized computer system. Examples of such a computing system can include one or more mobile devices (e.g., laptop computer, smart phone, personal digital assistant, tablet computer, or other mobile device, game console), desktop computers, servers, blades in a server chassis, or any other type of computing device(s) that include at least the minimum processing power, memory, and input and output device(s) to perform one or more embodiments of the invention.

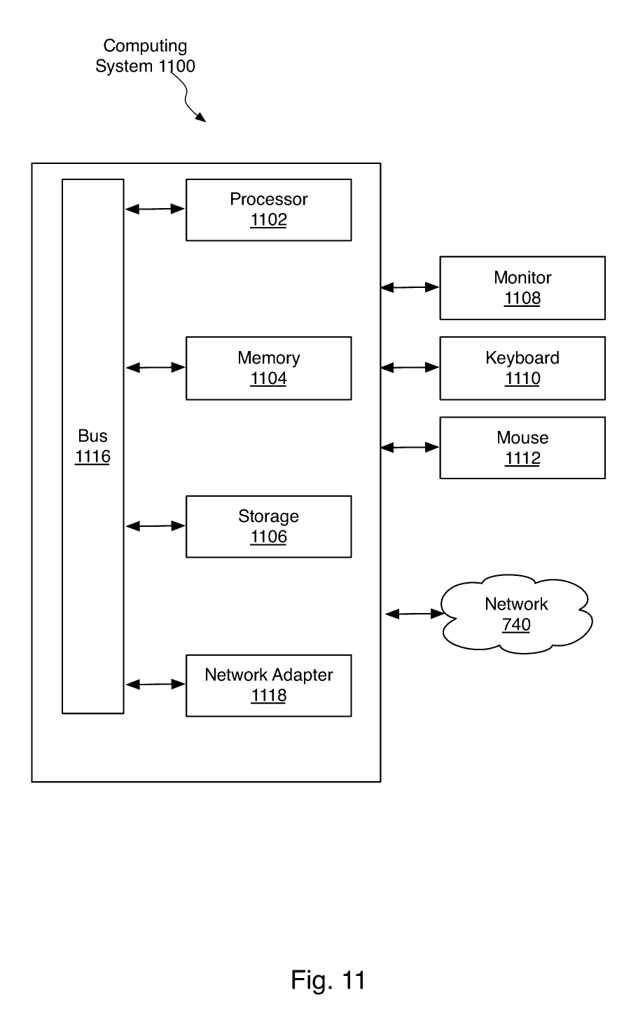

FIG. 11 illustrates a computing system 1100 upon which portions of the patient care reconnaissance system 100 can be implemented. For example, the intelligence center 140 can be implemented in code on a computing system such as the computing system 1100.

The computing system 1100 includes one or more computer processor(s) 1102, associated memory 1104 (e.g., random access memory (RAM), cache memory, flash memory, etc.), one or more storage device(s) 1106 (e.g., a hard disk, an optical drive such as a compact disk (CD) drive or digital versatile disk (DVD) drive, a flash memory stick, etc.), a bus 1116, and numerous other elements and functionalities. The computer processor(s) 1102 may be an integrated circuit for processing instructions. For example, the computer processor(s) may be one or more cores or micro-cores of a processor. The computing system 1100 may also include one or more input device(s), e.g., a touchscreen, keyboard 1110, mouse 1112, microphone, touchpad, electronic pen, or any other type of input device. Further, the computing system 1100 may include one or more monitor device(s) 1108, such as a screen (e.g., a liquid crystal display (LCD), a plasma display, touchscreen, cathode ray tube (CRT) monitor, projector, or other display device), external storage, input for an electric instrument, or any other output device. The computing system 1100 may be connected to the network 740 (e.g., a local area network (LAN), a wide area network (WAN) such as the Internet, mobile network, or any other type of network) via a network adapter 1118.

While the foregoing disclosure sets forth various embodiments using specific diagrams, flowcharts, and examples, each diagram component, flowchart step, operation, and/or component described and/or illustrated herein may be implemented, individually and/or collectively, using a range of processes and components.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While the invention has been described with respect to a limited number of embodiments, those skilled in the art, having benefit of this disclosure, will appreciate that other embodiments may be devised which do not depart from the scope of the invention as disclosed herein.

What is claimed is:

1. A patient care reconnaissance system, comprising:
a set of patient tags each for identifying a respective patient;
a set of care provider tags each for identifying a respective care provider;
a set of proximity detectors capable of communicating with the patient and care provider tags and obtaining a set of parameters describing each of a set of care interactions involving the patients and the care providers; and
an intelligence center that gathers the parameters from the proximity detectors and that in response to a request generates a depiction of a process of care for at least one of the patients.

2. The patient care reconnaissance system of claim 1, wherein each set of parameters includes a unique patient identifier sampled from the patient tag of the patient involved in the corresponding care interaction and a unique care provider identifier sampled from the care provider tag of the care provider involved in the corresponding care interaction.

3. The patient care reconnaissance system of claim 1, wherein each set of parameters includes a timestamp for the corresponding care interaction.

4. The patient care reconnaissance system of claim 1, wherein each set of parameters includes a unique detector identifier of the corresponding proximity detector that identifies a location of the corresponding care interaction.

5. The patient care reconnaissance system of claim 1, wherein the depiction includes an indication of at least one location associated with at least one of the patients.

6. The patient care reconnaissance system of claim 1, wherein the depiction includes an indication of at least one of the care interactions.

7. The patient care reconnaissance system of claim 1, wherein the depiction includes an indication of one of the care providers having a most recent care interaction with at least one of the patients.

8. The patient care reconnaissance system of claim 1, wherein the depiction includes an indication of a current location of the patient nearest to a current location of a particular one of the care providers.

9. The patient care reconnaissance system of claim 1, wherein the depiction includes a timeline of a series of the locations visited by a corresponding one of the patients.

10. The patient care reconnaissance system of claim 1, wherein the parameters include a set of parameters generated in response to a care interaction detection signal from the patent and care provider tags involved in corresponding care interaction.

11. The patient care reconnaissance system of claim 1, wherein the depiction includes a spatial-temporal history of at least one of the care providers sampled by the proximity detectors.

12. A method for patient care reconnaissance, comprising:
obtaining a set of parameters from a set of patient tags and a set of care provider tags in at least one of a set of predetermined locations, each set of parameters describing a respective care interaction involving a set of patients and a set of care providers identified by the patient and care provider tags;
associating each set of parameters with an identifier of the corresponding predetermined location; and
receiving the parameters from the predetermined locations and in response to a request generating a depiction of a process of care for at least one of the patients.

13. The method of claim 12, wherein obtaining comprises:
sampling a unique patient identifier from at least one of the patient tags;
sampling a unique care provider identifier from at least one of the care provider tags; and
comparing a timestamp and the predetermined location associated with the unique patient identifier to a timestamp and the predetermined location associated with the unique care provider identifier.

14. The method of claim 12, wherein generating a depiction comprises generating an indication at least one of the predetermined locations associated with at least one of the patients.

15. The method of claim 12, wherein generating a depiction comprises generating an indication of at least one of the care interactions.

16. The method of claim 12, wherein generating a depiction comprises generating an indication of one of the care providers having a most recent care interaction with at least one of the patients.

17. The method of claim 12, wherein generating a depiction comprises generating an indication of a current location of the patient nearest to a current location of a particular care provider.

18. The method of claim 12, wherein generating a depiction comprises generating a timeline of a series of the predetermined locations visited by at least one of the patients.

19. The method of claim 12, wherein generating a depiction comprises generating a spatial-temporal history of at least one of the care providers.

20. A patient care reconnaissance system, comprising:
a patient tag for identifying a patient;
a set of proximity detectors each capable of sampling a respective set of patient location parameters when the patient tag is in range; and
an intelligence center that gathers the patient location parameters from the proximity detectors and that generates a depiction of a spatial-temporal history of the patient sampled by the proximity detectors.

21. The patient care reconnaissance system of claim 20, wherein each set of patient location parameters includes a unique detector identifier for the corresponding proximity detector that identifies a location for the spatial-temporal history.

22. The patient care reconnaissance system of claim 20, wherein each set of patient location parameters includes a timestamp that identifies a time at the corresponding location for the spatial-temporal history.

23. The patient care reconnaissance system of claim 20, wherein each set of patient location parameters includes a unique patient identifier sampled from the patient tag that identifies the patient for the spatial-temporal history.

24. The patient care reconnaissance system of claim 20, wherein the spatial-temporal history includes a series of one or more locations visited by the patient.

25. The patient care reconnaissance system of claim 20, wherein each proximity detector is capable of sampling a respective set of care provider location parameters including a timestamp and a unique detector identifier when a care provider tag for identifying a care provider is in range, such that the intelligence center gathers the care provider location parameters and includes a depiction of a care interaction between the patient and the care provider in the spatial-temporal history in response to the care provider location parameters.

26. The patient care reconnaissance system of claim 25, wherein the intelligence center detects the care interaction by comparing a set of timestamps and a set of unique detector identifiers in the patient location parameters to the timestamps and the unique detector identifiers in the care provider location parameters.

27. A method for patient care reconnaissance, comprising:
obtaining a respective set of patient location parameters in at least one of a set of predetermined locations;
associating each set of patient location parameters with an identifier of the corresponding predetermined location; and
receiving the patient location parameters from the predetermined locations and generating a depiction of a spatial-temporal history of a patient in response to the patient location parameters.

28. The method of claim 27, wherein obtaining a respective set of patient location parameters comprises obtaining a timestamp that identifies a time at the corresponding location for the spatial-temporal history.

29. The method of claim 27, wherein obtaining a respective set of patient location parameters comprises obtaining a unique patient identifier from the patient tag that identifies the patient.

30. The method of claim 27, wherein generating a depiction includes generating a depiction of a series of the predetermined locations visited by the patient.

31. The method of claim 27, further comprising obtaining a respective set of care provider location parameters from a care provider tag at one or more of the predetermined locations and associating each set of care provider location parameters with one of the identifiers and including a depiction of a care interaction between the patient and the care provider in the spatial-temporal history in response to the care provider location parameters.

32. The method of claim 31, further comprising detecting the care interaction by comparing a set of timestamps and a set of identifiers in the patient location parameters to the timestamps and the identifiers in the care provider location parameters.
